(19) United States
(12) Patent Application Publication
(10) Pub. No.: US 2016/0187910 A1
(43) Pub. Date: Jun. 30, 2016

(54) Unit and Method for Energy Regulation of an Electrical Production and Consumption System

(71) Applicant: M ET R ENERGIES, Aubagne (FR)

(72) Inventor: Patrice MORENO, MARSEILLE (FR)

(73) Assignee: M ET R ENERGIES, Aubagne (FR)

(21) Appl. No.: 14/902,614

(22) PCT Filed: Jul. 3, 2014
(86) PCT No.: PCT/FR2014/051717

§ 371 Date: Jan. 4, 2016

(30) Foreign Application Priority Data
Jul. 4, 2013 (FR) 1356592

(51) Int. Cl. G05F 1/66; G05B 15/02

(52) U.S. Cl. CPC G05F 1/66; G05B 15/02

(57) ABSTRACT

The present invention relates to a unit and a method for energy regulation of an electrical production and consumption system as well as such a system. The regulating unit (1) comprises means for storing a plurality of estimated mean production and/or consumption values, means for decoding the instantaneous productions and/or consumption thus measured, processing means for calculating the average instantaneous productions and/or consumption measured per given time period, calculating and recording the deviation between each instantaneous average production or consumption thus calculated and each estimated production or consumption value, and formulating/generating and revising an estimated and previously recorded production and/or consumption value, as well as means for driving the system regulation means according to a function whose parameters comprise the production and/or consumption values estimated for the current given time period.

The present invention relates to a unit and a method for energy regulation of an electrical production and consumption system as well as such a system. So-called smart electrical production and/or consumption systems are being developed every year. They are also referred to as “smart grids.” Electricity cannot be stored in an easy, quick and economical manner. In addition, more and more systems are being developed which seek, among other things, to adjust the production and distribution of electricity in real time, particularly through the prioritization of consumption needs and the emergencies thereof. Such systems use digital and/or computer technologies. They make it possible to aggregate and control the production and consumption of electricity of a particular site in order to improve and optimize energy efficiency.

In such electrical production and/or consumption systems, digital devices receive information from various sensors measuring instantaneous electrical production or consumption. One or more human operators, aided by calculations of production and/or consumption performed digitally by those devices, adjust the production or consumption in order to adapt them to one another. Moreover, such digital devices can enable the detection of failures at a site.

It is also possible to control the production of several electricity production units, such as, as non-limitative examples, the external power grid at the site, one or more generator sets, batteries or accumulators present at the site and renewable energy stations. For this reason, the management of the production of renewable energy plants, such as, for example, in an advantageous but non-limitative manner, a photovoltaic plant or a wind farm, can be improved: indeed, the electrical production of such plants can vary randomly and unpredictably.

In all of these cases, one or more human operators present at a site are or remain responsible for tasking between the production and consumption of electricity. For this reason, the management of such plants is not automated despite the use of digital technologies. Digital technologies merely aid human operators in their decision-making. They do not pass the monitoring and regulation of the electrical production and consumption system to them per se. Document WO-A-2013/026673 relates to the regulation of an industrial facility on the basis of the consumption of electrical power. Besides the consumption of electrical power, other parameters, for example in relation to an energy supplier or in relation to the facility itself, enable the electrical production of the installation to be adapted to the consumption of electrical power.

According to this document, several power production units are exploited in order to avoid network overloads by increasing the amount of electricity made available. However, this document does not describe the automatic controlling of the installation. At most, the production is adapted to the actual consumption.

In relation to renewable energies, for example, document EP-A-2 562 901 describes a process for the management of the electrical production of at least two electrical production units according to the meteorological conditions. The process according to this document comprises steps consisting of:
providing meteorological forecast data for the production units;
generating, for each power production unit, a plurality of scenarios indicating the future energy production according to the meteorological forecast data;
identifying several scenarios with a specific scenario for each unit and a unique combined scenario for controlling the at least two units simultaneously.

This document relates only to the controlling of renewable energy units. It does not relate to the controlling of a complete electrical production and consumption system.

According to the previously described art, the regulating means implement priority rules for requesting production sources. Those rules are only based on the instantaneous production and consumption levels. For this reason, such regulating units according to the prior art cannot automatically anticipate any production deficit or consumption excess of the regulated system, or even automatically command a production surplus for later consumption.

It is the object of the present invention to provide a unit and a method for regulating the production and consumption of an electrical production and consumption system that anticipates the productions and consumptions of electricity and controls the system automatically while minimizing interventions by human operators to maintain the system.

To this end, the invention provides a power regulation unit of an electrical production and consumption system, the system comprising:
an electrical power consumption unit,
an electrical power production station comprising two distinct production units, the power station supplying electrical power to the consumption unit,
means for measuring instantaneous electrical power productions delivered respectively by the production units;
means for measuring the instantaneous electrical power consumption of the consumption unit,
means for regulating the respective production of the production units according to the electrical power consumed by the consumption unit,
means for controlling the means for regulating the system according to a predetermined function.

In order to minimize the intervention of human operators, the regulating unit according to the invention comprises:
a. means for storing a plurality of estimated average electrical production values and/or of estimated average electrical consumption values from each respective production unit and/or from the at least one consumption unit, respectively, for a plurality of given time periods;
b. means for decoding the instantaneous electrical productions and/or the electrical consumption measured by the measuring means;
c.. processing means for:
i. calculating the average instantaneous productions and/or consumption measured per given time period to obtain average instantaneous productions and/or average instantaneous consumption per given time period;
ii. calculating and recording on the storing means the difference between each average instantaneous production calculated in this way and each estimated production value for the same given time period if and only if such an estimated production value exists;
iii. calculating and recording on the storing means the difference between the average instantaneous consumption calculated in this way and the estimated consumption value for the same given time period if and only if such an estimated consumption exists;
iv. generating and revising an estimated and previously-recorded production and/or consumption value for one or more given future time periods based on a relationship having as parameters the estimated value and one or more differences respectively calculated for one or more given lapsed time periods.

Moreover, the function implemented by the means for controlling the regulating means comprises parameters including estimated production values and/or consumption values for the given current time period.

A regulation unit according to the invention makes it possible to control the production and consumption of a system based on previously estimated data and instantaneous measurements, thus ensuring more stable regulation of the system and clearing one or more human operators from the responsibility of managing the production and consumption of electricity in the system in an ad hoc manner. Likewise, it is possible to anticipate any production deficit or any consumption excess. As a non-limitative example, if a meteorological deficit is anticipated, specifically because of insufficient sunshine or a lack of wind, the regulation unit can then decide, by adjusting the estimated values, to request even more production sources than the renewable energy source. Likewise, alternatively or in addition, if an economic interest in reselling electricity is foreseen in the near future, it is possible, for example, to store more electricity than it is needed in order to enable it to be sold later at a more favorable time. Such possibilities were not available with the regulating units according to the prior art, which are purely active and have no ability to anticipate.

To collect the measurements, the regulation unit can comprise communication means for cooperating with the means for measuring the instantaneous productions and/or consumption of electrical power of the system.

To enable warnings regarding the regulation process, particularly about possible failures, to be given to one or more human operators in certain situations, the regulation unit according to the invention can comprise communication means for cooperating with a man-machine interface, the regulation unit triggering the issuance of an alert—via the communication means—to the interface as soon as the accumulation of one or more differences respectively calculated for one or more consecutive time periods is greater in terms of absolute value than a predetermined threshold.

To reduce the cost of regulation and/or to centralize them, the regulating unit according to the invention can simultaneously control several electrical production and consumption systems, the regulation unit comprising a sub-regulation unit for each controlled system, the sub-unit being equipped with its own means for storing, decoding, calculating and controlling the means for regulating the associated system.

According to a second object, the invention relates to a system for the production and consumption of electrical power comprising:
an electrical power consumption unit, an electrical power production station comprising two distinct production units, the power station supplying electrical power to the consumption unit;
means for measuring the instantaneous production of electrical power delivered by the production units;
means for measuring the instantaneous electrical power consumption of the consumption unit;
means for regulating the respective production of the production units based on the electrical power consumed by the at least one consumption unit. The regulating means are controlled by the means for controlling a regulation unit according to the invention.

Advantageously, the production units can respectively be a generating set and power storage unit functioning alternatively as a production unit and consumption unit. In order to benefit from lower-cost energy, the electrical power production station can comprise a renewable energy unit in the form of a photovoltaic, wind, geothermal, hydraulic, cold fusion reactor or equivalent plant as well as a connection to an external power grid.

According to a third object, the invention relates to a regulation method implemented by a power regulation unit according to the invention, the method comprising the following steps:
a. storage of a plurality of estimated average electrical production values and/or of estimated average electrical consumption values from each respective production unit and/or from the at least one consumption unit, respectively, for a plurality of given time periods;
b. decoding of the instantaneous electrical production and/or consumption measured by the measuring means;
c1. calculation of the respective measured average instantaneous production and/or consumption levels per given time period to obtain average instantaneous production and/or average instantaneous consumption per given time period;
c2. calculation and recording of the difference between average instantaneous production calculated in this way and an estimated production value for the same given time period if and only if such an estimated production value exists;
c3. calculation and recording of the difference between the calculated average instantaneous consumption and the estimated consumption value for the same given time period if and only if such an estimated consumption value exists;
c4. generation and revision of an estimated and previously-recorded production and/or consumption value for one or more given future time periods based on a relationship having as parameters the estimated value and one or more differences respectively calculated for one or more given lapsed time periods;
d. controlling means for regulating the system based on a function whose parameters comprise the estimated production and/or consumption values for the given current time period. In order to notify one or more human operators about the progression of the regulation process, the regulation method—when the regulation unit comprises communication means for cooperating with a man-machine interface—can comprise a step for issuing an alert via the man-machine interface as soon as the accumulation of one or more differences respectively calculated for one or more consecutive time periods is greater than a predetermined threshold.

Alternatively or in addition, particularly in order to alert one or more human operators of a possible malfunction of a piece of equipment at the site (production or consumption), or even of estimated data that are too far from the collected measurements, such a method can comprise a step for issuing an alert via the man-machine interface as soon as a calculated difference between an average instantaneous consumption and/or production value and a corresponding estimated value for a given time period exceeds a predetermined threshold in terms of absolute value.

Finally, the invention relates to a computer program to be recorded and implemented, respectively, by storage means and processing means of such a regulation unit, the program comprising one or more program instructions which, when they are interpreted or executed by the processing means, triggers the implementation of such a method de regulation.

Other characteristics, aims and advantages of the present invention will become evident in reading the detailed description that follows and in viewing the enclosed drawings, which are given as non-limitative examples and in which:

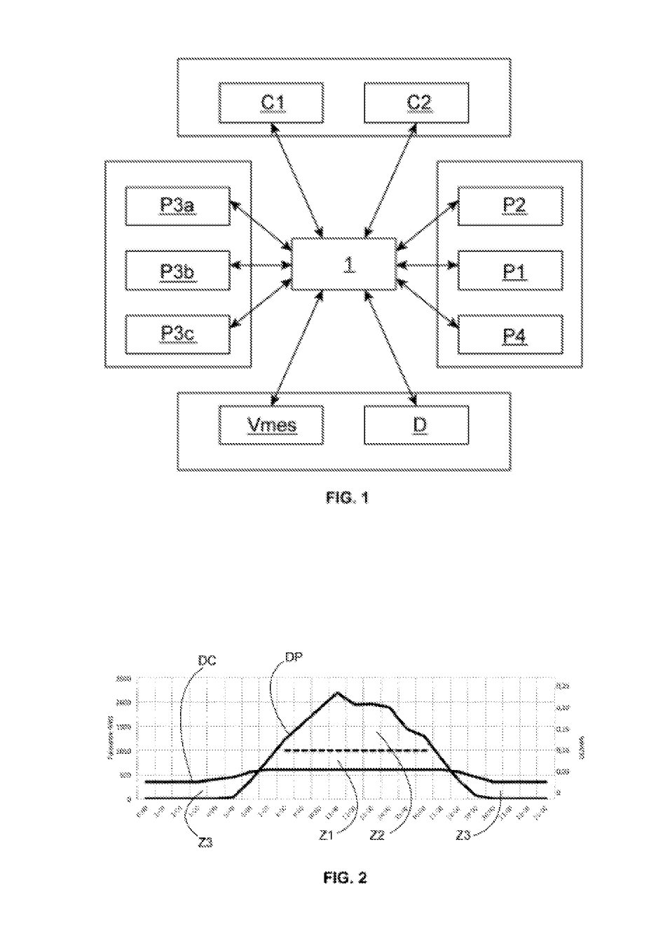

FIG. 1 is a schematic representation of a power regulation unit of an electrical production and consumption system according to the present invention, the system being controlled by the unit,

FIG. 2 presents input/output diagrams of the electrical production and consumption, respectively, of an electrical production and consumption system for one full day, the diagrams providing data that can be stored and decoded in the regulation unit according to the present invention.

FIG. 1 schematically illustrates the operating of a power regulation unit of an electrical production and consumption system, the unit 1 being according to the present invention. A regulation unit 1 controls and regulates at least one electrical production and consumption system. Such an electrical production and consumption system comprises an electrical power production station which, in turn, comprises a plurality of production units P1, P2, P3a to P3c, P4 and one or more consumption units C1 and C2.

According to a preferred embodiment, an electrical power production and consumption system comprises a first electrical production unit P1, which advantageously forms the primary production unit and can be, to name a non-limitative example, a generating set. Such a system also comprises a second production unit P2, which can be an electrical power storage group in any form. The term “generating set” refers to any large- or small-sized installation or device able to supply electricity.

In an advantageous but non-limitative manner, the production unit P1 can comprise one or more generator sets of different types, ranging from a thermal station to a portable generating set depending on the production and consumption system being considered. Like the production unit P1, the production unit P2 can comprise one or more electricity storage groups, advantageously but not necessarily in the form of one or more batteries or accumulators having possibly different load capacities.

Such storage groups can be regarded as a production unit when they return their stored energy but also as a consumption unit when they are being charged, i.e., when they are being supplied by others production units.

Other electricity production units can be exploited. They can be renewable energy stations referenced as P3a, P3b and P3, or even a link or connection to an external power grid P4. Such units can act individually or in combination for the electrical production of the system. As a non-limitative example, a renewable energy station can be a photovoltaic plant, a wind farm, a geothermal or hydraulic station, a cold fusion reactor, or technical equivalents.

Advantageously, an order of priority can be defined and implemented by regulating means of the system for requesting the units P1, P2, P3a, P3b and P3c and the connection to the grid P4. It is possible to prioritize the use of the production unit P1 formed by the generator sets, the renewable energy unit P3a, P3b and P3c in relation to the storage unit P4, the connection to a grid P4 advantageously having the lowest priority among the modes of electrical production. The production and consumption system comprises means for measuring instantaneous electrical power productions delivered respectively by the two production units P1, P2, P3a, P3b, P3c and P4. It further comprises means for measuring the instantaneous electrical power consumption of the consumption unit C1 and C2.

The consumption unit or units C1 and C2 depend on the system in question. To name non-limitative examples, such consumption units C1 and C2 can be residences, factories, workplaces, etc.

The means for regulating the respective production levels of the production units P1, P2, P3a, P3b, P3c and P4 according to the electrical power consumed by the consumption unit C1 and C2 are controlled automatically by a regulation unit 1. The regulation unit 1 will be described in further detail below.

The measuring means can be sensors and/or electrical counters. Such measuring means can be used to calculate measured production and/or consumption values Vmes, then for calculating the estimated values particularly on the basis of the measured values Vmes, the latter being advantageously averaged and corrected for lapsed periods.

Other means for collecting parameters and/or for storing parameter histories can be provided, such means not being directly related to production and/or consumption parameters. Such measuring means and/or storage means can be related to exterior parameters D, such as meteorological parameters, for example, which can have an influence on electrical production and consumption.

Alternatively, the parameters D can relate to the supplying of electricity from an external power grid through a connection or, conversely, the supplying of electricity to this grid. The system, controlled by the regulation unit 1, can thus contribute to the stability of the electrical distribution grid by consuming or injecting electricity active or reactive power on the grid. The measured or estimated values can advantageously take forecasted hours of strong consumption into account for which the grid will preferably not be used.

For example, in an advantageous but non-limitative manner, the technical parameters of the distribution and transport grid that are considered can be the availability, the variation in electrical tension on the grid the variation in frequency.

When a renewable energy station is present within the electrical production and consumption system, the technical parameters considered can advantageously but not necessarily be irradiation, external temperature, wind speed, the number of hours of sunshine or duration of the wind, the ageing of the station, and the inverters of this station.

Thereafter, the measured production and/or consumption values Vmes and the data D having an indirect impact on the production and/or consumption are transmitted from the measuring means of the system to the regulation unit 1 to be stored and used for the calculation of the respective estimated values.

A regulation unit 1 according to the invention collects, decodes or even stores, and processes the measured values Vmes and the data D that are sent to it, particularly by the measuring means. The measurements of parameters of the electricity production units, the consumption lines or even the parameters pertaining to the environment can be collected and processed by the regulation unit 1, the unit advantageously comprising communication means for cooperating with the means for measuring the instantaneous production and/or consumption of electrical power of the regulated system.

Via the measuring means, which communicate by means of a wired or wireless network, the regulation unit 1 is “connected” to the different electrical production units. As a function of the nature of the sources, different parameters are measured. The nature of these parameters as well as the frequency of the measurements depend directly on the type of production unit. In an advantageous but non-limitative manner, the considered technical parameters of the system can be electrical tension, electrical current, the active, reactive or apparent power, and the frequency.

In the specific case of a storage group, it being possible for such a group to contain several batteries of different types with, for example, different capacities and voltages, the technical parameters considered of such a group can be, advantageously but not necessarily, the charging and discharging cycle, the discharging threshold, the temperature, charge level, and ageing.

In the specific case of a generating set, it being possible for such a generating set to contain one or more generators, primary fuel oil or gas oil generators, the technical parameters considered of such a group can be the availability of each generator and the level of fuel oil and gas oil remaining in the generator.

The regulation unit 1 can thus be “connected” to sources of local meteorological forecasts, recording or storing local past and instantaneous meteorological data in order to compare and correct the estimated values for each production and/or consumption unit in order to ultimately anticipate the levels of electrical production and consumption for the following days.

In all cases, the regulation unit 1 implements one or more modes of communication with the different elements of the system, for example in sets of queries and answers or in response to the receipt of unsolicited events with the system or coming from sources of data D from outside of the system, particularly for the meteorological forecasts or histories.

In the case of acquisition in sets of queries and answers, these are the means for collecting or decoding the regulation unit that periodically issues one or more queries to the different data sources.

Before any processing of a new value Vmes or of new data D, processing means, for example a microcontroller, of the regulation unit 1 can verify that the value is not an outlier. For this purpose, the value is compared to previous measurements if any have been recorded. If the value is too far from the median value, it can be dismissed from any processing and be identified in the base as an outlier value.

During storage of a new value Vmes or of new data D, if the latter is to be the subject of special monitoring, the processing means can calculate the trend of the value or data. The objective of this calculation is to identify the evolution of the value and to compare it to different thresholds.

The calculation can be a weighted trend. In that case, the averaged value is weighted or reconciled with another variable. The weighted calculation makes it possible to fine-tune the control and to compare the values of a parameter that depends strongly on its environment. Solar yields can thus be compared by reconciling the generated power with the solar radiation.

According to the present invention, the power regulation unit 1 of such an electrical production and consumption system can comprise means for storing a plurality of estimated average electrical production and/or consumption values, respectively, of each production unit P1, P2, P3a, P3b, P3c and P4 and/or of the at least one consumption unit C1, C2, respectively, for a plurality of given time periods.

With the exception of the initial commissioning of the system, for which no history is available in terms of values Vmes measured by the sensors for lapsed periods, the estimated average production and/or consumption values can be established, particularly as a function of the values Vmes measured by the sensors for lapsed periods, these measured values Vmes forming a production and/or consumption history. Data D having an impact on production and/or consumption can also be taken into consideration.

Advantageously but not necessarily, the data D can be technical parameters, costs, real-time meteorological data, historical meteorological data, equipment maintenance forecasts, or probabilities of breakdowns involving down time for one or more production or consumption units, building insulation data, average consumption conditions specific to each housing unit, estimations of electrical losses, the forecast for the number and power of one or more production or consumption units estimated as a function of a given instance, etc.

Such values Vmes and data D can therefore have been or be measured by the system or outside of the system, such as, for example, in the case of production or consumption histories, or simply estimated, such as, for example, in the case of meteorological forecasts or forecasts for the breakdown or operating of production and/or consumption units. If the values Vmes can be directly correlated to production and/or consumption, the data D only has an indirect influence on production or consumption. Alternatively, meteorological forecasts can be prepared statistically from meteorological histories that have been established over several years.

Thus, for the power sources depending on meteorological parameters, the device can have values from models for estimating energy production. This estimation takes current meteorological parameters into account but also detailed meteorological estimations established one or two days in advance.

For the production levels, estimated values can take ageing and the loss of efficiency of one or more production units into account.

These values can also pertain to the durations and frequencies of unavailability for the purpose of the preventive, recurrent or curative maintenance of one or more production or consumption units.

Thus, based on these estimated values, the regulation unit 1 of the system can anticipate failures and interruptions in the power supply. As a function of the data collected, such as, for example, events, alarms and various measurements, or even equipment characteristics such as the mean time between failures, otherwise known as MTBF, manufacturer recommendations, the regulation unit 1 can determine the maintenance intervention intervals and/or material replacement intervals. These data can also be taken into account in the preparation of theoretical production curves. The regulation unit can then generate an alert for one or more human operators via a suitable man-machine interface such as that which will be described below.

A few estimated or measured data can involve the costs of electricity in order to enable the regulation unit 1 of the system to take into account the costs for the optimization of the maintenances in the system.

For consumption, an archiving of consumption can be performed. The regulation unit 1 of the system can thus collect, or even decode and record a complete or partial history of the overall measured consumption or of the measured consumptions for each consumption line. A forecast can be established which, on the basis of collected or theoretical data, determines estimated need in terms of energy consumption. Cyclical consumption rules or rules based on exterior parameters can be identified, refined and applied, for example cycles, exterior temperatures, wind force, sunshine, etc.

The regulation unit 1 also comprises means for decoding the instantaneous electrical production and/or the electrical consumption measured by the measuring means and storage means for recording estimated or theoretical consumption and/or production data.

The regulation unit 1 also comprises processing means for calculating measured average instantaneous productions and/or consumptions per given time period in order to produce average instantaneous production levels and/or an average instantaneous consumption level per given time period.

Furthermore, the processing means can calculate and record within storage means a difference between each average instantaneous production level calculated in this way and each estimated production value for the same given time period, if and only if such an estimated production value exists.

The processing means can thus calculate and record, on the storage means, the difference between the calculated average instantaneous consumption and the estimated consumption value for the same given time period, if and only if such an estimated consumption exists.

On the basis of such a difference over a lapsed time period or differences over several lapsed time periods, the processing means can prepare and revise an estimated and previously-recorded production and/or consumption value for one or more given future time periods based on a relationship having as parameters the estimated value and one or more differences respectively calculated for one or more given lapsed time periods.

In order to impart anticipation capabilities to the system, the regulation unit 1 can also comprise means for controlling the means for regulating the system based on a function whose parameters include the estimated production and/or consumption values for the given current time period. The means for controlling the regulating means can advantageously consist of the processing means of a regulation unit according to the invention. Alternatively, the controlling means can cooperate with the processing means and benefit from data such as differences or an update of estimated data produced, for example, by the processing means. The regulating means thus request the production sources according to a pre-established priority and no longer simply as a reaction to the exploitation of the instantaneously measured production and/or consumption values, but by also exploiting the estimated production and/or consumption values that may have been revised.

In general, an estimated production and/or consumption value for one or more given future time periods can be revised, that is, increased or decreased based on the direction of the difference or differences and as a function of the size of the difference or differences.

In order to implement the previously mentioned means of the regulation unit 1, the processing means of the regulation unit advantageously implement a computer program recorded on the storage means cooperating with the processing means, the program comprising one or more program instructions which, when interpreted or executed by the regulation unit 1, specifically by its processing means, trigger the implementation of the regulation method.

As shown in FIG. 1, the regulation unit 1 can be integrated into the electrical production and consumption system. Alternatively, the regulation unit 1 can be arranged at a distance from the system, communicating with it by means of suitable communication means by internet-type wired connection, by satellite link or by radio channels, GSM, carrier currents or the like.

According to the present invention, the unit and the regulation method enable the production and consumption of the system to be controlled as a function of previously estimated measures. Such a unit and such a method thus strongly reduce the queries and/or intervention of human personnel. Together with the updating or revision of estimated production and/or consumption values, a method according to the invention can trigger the issuance of an alert to one or more operators with an aim to obtaining human verification of the updated or revised estimated values.

Such a regulation unit 1 can thus comprise communication means for cooperating with a man-machine interface, the communication means further cooperating with the processing means of the unit 1, the latter triggering the issuance of an alert through the communication means to the interface.

A first alert can be triggered by the processing means of the regulation unit immediately upon accumulation of one or more differences, the differences being determined by the processing means between an average instantaneous consumption and an estimated consumption value for the same given time period, respectively, over one or more consecutive time periods, is greater in terms of absolute value than a predetermined threshold Likewise, an alert can be triggered immediately upon accumulation of one or more differences, always determined by the processing means, between an average instantaneous production level and a corresponding estimated production value for the same given time period, respectively, over one or more consecutive time periods is greater in terms of absolute value than a predetermined threshold. These two alerts indicate that, although the regulation unit is attempting to revise the estimated data based on a relationship that integrates real measured data, the difference between revised and measured estimations is growing inexorably, indicating a divergence.

To reduce the number of revisions, the processing means can consider that a difference calculated between an average measurement and data estimated over a given period belonging to a predetermined interval around 0 is zero. Such a difference can therefore be ignored and does not necessarily lead to a revision. When appropriate, a revision implemented by the processing means of the regulation unit 1 can take several differences calculated over several lapsed time periods into account, the number of these periods advantageously being greater than or equal to 3, these lapsed periods preferably being directly consecutive.

Independently of a revision of estimated production and/or consumption values, when one or more differences between respective measured values Vmes are encountered by the regulation unit 1, estimated values can be updated in order to incorporate new measured values Vmes into the old values measured during already-lapsed time periods and forming part of the production and/or consumption history.

A regulation unit according to the invention can store a difference evaluated between each average instantaneous production or consumption calculated in this way and each estimated production or consumption value for the same given time period. Such storage can pertain to the difference between, on the one hand, the difference of each average instantaneous production level reduced by the average instantaneous consumption and, on the other hand, the difference of each measured average production level reduced by the measured average consumption.

The regulation unit can thus compare values resulting from the difference between instantaneous production and consumption and values resulting from the difference between measured and/or estimated production and consumption.

Two preferred embodiments make it possible to access past measurements. According to a first variant, the processing means of the regulation unit command the storage or recording of the past measurements within storage means of the regulation unit. In a second variant, it is possible to store only the differences between averaged estimations and measurements in the storage means.

In this way, a regulation unit according to the invention such as, for example, the unit 1, can be constantly learning, including during its operation or exploitation.

Outlier or missing values can be spotted by the processing means of the regulation unit and replaced as mentioned above.

FIG. 2 shows input/output diagrams of estimated production DP and estimated consumption DC, respectively, over the course of an entire day. The diagrams relate to at least two electrical production units, these production units advantageously being a photovoltaic plant associated with an auxiliary storage unit. This FIG. 2 shows a non-limitative example of the implementation of the present invention.

At night, i.e. at every beginning and end of a day, the production diagram DP of the photovoltaic plant shows electrical production that is less than the consumption, the consumption load diagram being greater than the production diagram. The production deficit zones Z3 of the photovoltaic plant are compensated for by the production of the storage unit and/or by diesel secondary generators or the like.

Over the course of the day, the production load diagram DP is greater than the consumption load diagram DC. A benefit can be drawn from this surplus production in order to recharge a storage unit in zone ZI. If enough electrical production is left over, it is conceivable for electricity to be sold to the external grid, which corresponds to zone Z3. The processing means of the regulation unit can, with the aid of estimated data reflecting the expected load schedule, anticipate the amount of electricity that can be stored for a later time period.

A regulation unit according to the invention can simultaneously control several electrical production and/or consumption systems. In such a case, the regulation unit 1 comprises a regulation sub-unit for each controlled system, the sub-unit being equipped with its own means for storing, decoding, calculating and controlling the means for regulating the associated system. For example, the regulation unit 1 can comprise either several groups of storage means, one storage means being provided per system, or partitioning in the storage means in order to record data belonging to several production systems. Moreover, these processing means can be configured so as to control different regulating means belonging to different systems.

The invention also relates to a regulation process implemented by such a power regulation unit 1 comprising a step in which a plurality of estimated production values and/or average electrical consumption values for each production unit and/or for the consumption unit of the system, respectively, are stored for a plurality of given time periods.

Such a method of regulation comprises a step involving the collection or even decoding of the instantaneous electrical production and/or consumption measured by the measuring means of the system. The decoding is preceded by the storage of a plurality of estimated production values and/or average electrical consumption values for each production unit and/or for the consumption unit, respectively, for a plurality of given time periods.

The method then comprises the following steps:
calculation of the respective measured average instantaneous production and/or consumption levels per given time period to obtain average instantaneous production and/or average instantaneous consumption per given time period,
calculation and recording of the difference between average instantaneous production calculated in this way and an estimated production value for the same given time period, if and only if such an estimated production value exists and the calculation and recording of the difference between the calculated average instantaneous consumption and the estimated consumption value for the same given time period, if and only if such an estimated consumption value exists.

In fact, according to some embodiments, the invention makes a provision that the production and/or consumption can be estimated. In the event that the production or consumption is not estimated, the calculation of a difference is baseless. The processing means can thus replace, in the storage means of the regulation unit, estimated data for the controlling means for regulating the system using measured average instantaneous values for each period of time.

Such calculation steps are followed by a step in which an estimated production and/or consumption value previously-recorded for one or more given future time periods is generated and revised based on a relationship having as parameters the estimated value and one or more differences respectively calculated for one or more given lapsed time periods.

Such a relationship can, for example, consist in calculating, for the ith future time period t+i, a revision value d′(t+i) of a given piece of data d(t+i) such as

$${d}^{′} ( t + i ) = d ( t + i ) + \frac{{\sum }_{j ∈ [ 1 , n ]} {e}_{d} ( t - j )}{n}$$

where e_{d}(t) is the difference between the value of the estimated data and the average value of the measured data over a given time period t and n is the number of consecutive lapsed periods.

The method implemented by the processing means of a regulation unit according to the invention can comprise a step of controlling means for regulating the system based on a function whose parameters comprise the estimated production and/or consumption values for the given current time period.

According to a preferred but non-limitative embodiment, the measurement time periods can be between one and sixty minutes, the update taking effect on a date one to two days after the given period or the most recent given periods.

Different situations may arise afterward. For example, if the meteorological conditions are less favorable than expected, the solar radiation is less strong than forecast and/or the consumption increases due to the fact that homes must be heated more, the production values at a given instant, regulated by the estimated production values, may then be lower than estimated and the consumption values may then be higher than estimated. This leads to a production deficit that must be corrected. Revised estimated production values are then produced by the processing means of the regulation unit so that the revised estimated production values incorporate an increase in the electrical production associated or not associated with revised estimated consumption values, integrating an at least partial load-shedding of the consumption of electricity, so that the production diagram is at least greater than or equal to the consumption diagram at that given instant.

The increase in production commanded by the regulating means under the instruction of the control of the processing means of the regulation unit is carried out by the storage unit, although the latter cannot compensate for a production deficit over a long period. The increase in production can be achieved by increasing the production of the generator unit, the connection to the grid, or by calling upon other renewable energy plants not affected by the meteorological conditions.

The method according to the invention can comprise a step for triggering and transmitting one or more alerts and providing several levels of urgency in terms of correction: maintenance of a piece of equipment or “forced” revision, i.e., a new determination of production and/or consumption estimations for future periods.

Three modes for managing malfunctions or performance falling short of expectations will now be described for which an alert can be issued, the two latter situations being comparable to the detection of a malfunction of an element of the system requiring action by one or more human operators. Such alerts can advantageously be implemented by a regulation unit according to the invention.

According to a first management mode, an alert having a first level of urgency can be triggered by the processing means of a regulation unit and issued immediately upon accumulation of one or more differences respectively calculated over one or more consecutive time periods exceeding a predetermined threshold, the differences being calculated for each average instantaneous production level and each estimated production value for the same given time period and/or for each average instantaneous consumption and each estimated consumption value for the same given time period. A value of this threshold can be determined for example at a tenth of the average value of estimated data related to a number of given time periods. A gradation of difference thresholds can also be used to trigger attentive monitoring of the progression of the regulation, controlling the performance of certain equipment, or even—as indicated previously—to trigger an operation for updating or revising forecasts and thus the estimated data injected into the storage means of the regulation unit for future time periods.

According to a second management mode, which can correspond to the handling of an estimation that is too far from the actual value or to deterioration of on-site equipment, a difference or gap between the estimated values and respective instantaneous measured values for production and/or consumption whose value exceeds a second predetermined threshold can be calculated. As a non-limitative example, the second threshold can be determined such that if the measured value is less than 30% of the estimated value, the second threshold is reached. The regulation method can then comprise a step for issuing an alert having a second level of urgency, informing the maintenance or supervisory personnel of the system of possible deterioration of a piece of equipment requiring at least an installation check.

According to a third management mode, an abrupt variation in the measured values for production and/or consumption that is greater than a predetermined amplitude can arise during a given time period, the estimated production and/or consumption values for that time period not anticipating such an abrupt variation. In that case, a method implemented by a regulation unit according to the invention can comprise a step for issuing an alert, informing a supervising operator of an unexpected variation in the production and/or consumption. Such a phenomenon can be an unexpected and drastic breakdown of a production unit with a pronounced drop in electrical production that is not possible to compensate through the implementation of the usual available production units such as, for example, electrical power provided by the storage unit. This can be the case, for example, if a connection to an external power grid is desired but becomes impossible.

In order to attempt to bring the unexpected failures or degradations in performance under control, such a method of regulation can comprise a step for taking into account, in the estimated production and/or consumption values, the ageing of the production units and/or of the consumption unit(s) as well as the duration and frequency of unavailability for preventive, recurrent or corrective maintenance. Alternatively, a connection to an exterior electrical power grid is possible. In addition, the theoretical consumption and/or production curves can be updated by integrating an at least partial load-shedding of the consumption of electricity.

As shown in FIG. 2 and illustrated particularly by zone Z2, when the production curve DP exceeds the consumption curve DC and the storage unit is charged or enough electrical power remains in order to perform the charging of the storage unit, a regulation method according to the invention can comprise an operation involving the external sale of the electricity. The external sale of electricity can advantageously be controlled by the regulation unit as a function of variable sales prices of electricity, electricity being stored as long as a sales price threshold deemed to be too low is not crossed. Such sales prices can advantageously be contained in the measured or estimated values transmitted to the regulating unit according to the invention, electricity only being stored if a sales price threshold has not been crossed.

The invention is not limited in any way to the embodiments, which have been described and illustrated only for the sake of example.

1. A power regulation unit of an electrical production and consumption system, the system comprising:
an electrical power consumption unit,
an electrical power production station comprising two distinct production units, the power station supplying electrical power to the consumption unit,
means for measuring instantaneous electrical power production delivered respectively by the production units;
means for measuring the instantaneous electrical power consumption of the consumption unit;
means for regulating the respective production of the production units according to the electrical power consumed by the consumption unit;
means for controlling the means for regulating the system according to a predetermined function;
the regulation unit comprises:
a. means for storing at least one of i. a plurality of estimated average electrical production values and ii. estimated average electrical consumption values of at least one of i. each respective production unit and ii. the consumption unit respectively, for a plurality of given time periods;
b. means for decoding at least one of i. the instantaneous electrical production and ii. the instantaneous electrical consumption measured by the measuring means;
c. processing means for:
i. calculating at least one of i. the average measured instantaneous production and ii. consumption levels per given time period to obtain average instantaneous productions and iii. average instantaneous consumption per given time period;
ii. calculating and recording on the storing means the difference between each average instantaneous production calculated in this way and each estimated production value for the same given time period if and only if such an estimated production value exists;
iii. calculating and recording on the storing means the difference between the average instantaneous consumption calculated in this way and the estimated consumption value for the same given time period if and only if such an estimated consumption exists;
iv. generating and revising at least one of i. an estimated and previously-recorded production and ii. consumption value for one or more given future time periods based on a relationship having as parameters the estimated value and one or more differences respectively calculated for one or more given lapsed time periods;
and in that the function implemented by the means for controlling the regulating means comprises parameters including at least one of i. estimated production values and ii. consumption values for the given current time period.

2. The regulation unit according to claim 1, comprising communication means configured for cooperating with at least one of i. the means for measuring the instantaneous productions and ii. consumption of electrical power of the system.

3. The regulation unit defined according to claim 1, comprising communication means configured for cooperating with a man-machine interface, the regulation unit triggering the issuance of an alert—via the communication means—to the interface as soon as the accumulation of one or more differences respectively calculated for one or more consecutive time periods is greater in terms of absolute value than a predetermined threshold.

4. The regulation unit defined according to claim 1, which simultaneously controls several electrical production and consumption systems, the regulation unit comprising a sub-regulation unit for each controlled system, the sub-unit being equipped with its own means for storing, decoding, calculating and controlling the means for regulating the associated system.

5. An electrical power production and consumption system, comprising:
an electrical power consumption unit,
an electrical power production station comprising two distinct production units, the power station supplying electrical power to the consumption unit,
means for measuring the instantaneous production of electrical power delivered by the production units;
means for measuring the instantaneous electrical power consumption of the consumption unit;
means for regulating the respective production of the production units according to the electrical power consumed by the consumption unit;
wherein the regulating means are controlled by the means for controlling a power regulation unit defined according to claim 1.

6. The system defined according to claim 5, wherein the two production units comprise a generating set and a power storage unit respectively, functioning alternately as a production unit and consumption unit.

7. The system defined according to claim 5, wherein the electrical power production station comprises a renewable energy unit in the form of a photovoltaic, wind, geothermal, hydraulic, cold fusion reactor or equivalent station as well as a connection to an external power grid.

8. A regulation method implemented by a power regulation unit defined according to claim 1, the method comprising the following steps:
a. storing at least one of i. a plurality of respectively estimated average electrical production values and ii. estimated average electrical consumption values for at least one of i. each production unit and ii. each consumption unit, respectively, for a plurality of given time periods;
b. decoding of at least one of i. the instantaneous electrical productions and ii. consumption measured by the measuring means;
c1. calculating at least one of i. the respective measured average instantaneous production and ii. consumption levels per given time period to obtain average instantaneous production and iii. average instantaneous consumption per given time period;
c2.calculating and recording the difference between average instantaneous production calculated in this way and an estimated production value for the same given time period if and only if such an estimated production value exists;
c3. calculating and recording the difference between the calculated average instantaneous consumption and the estimated consumption value for the same given time period if and only if such an estimated consumption value exists;
c4. generating and revising at least one of i. an estimated and previously-recorded production and ii. consumption value for one or more given future time periods based on a relationship having as parameters the estimated value and one or more differences respectively calculated for one or more given lapsed time periods;
d. regulating the system based on a function whose parameters comprise at least one of i. the estimated production and ii. consumption values for the given current time period.

9. The method defined in claim 8, the regulation unit comprising communication means configured for cooperating with a man-machine interface, the regulation unit triggering the issuance of an alert—via the communication means—to the interface as soon as the accumulation of one or more differences respectively calculated for one or more consecutive time periods is greater in terms of absolute value than a predetermined threshold, further comprising a step for issuing an alert via the man-machine interface as soon as the accumulation of one or more differences respectively calculated for one or more consecutive time periods is greater than a predetermined threshold.

10. The method defined in claim 9, further comprising a step for issuing an alert via the man-machine interface as soon as a difference between at least one of i. an average instantaneous consumption and ii. production level and a corresponding estimated value for a given time period exceeds a predetermined threshold in terms of absolute value.

11. A computer program configured so as to be recorded and carried out, respectively, by storage means and processing means of a regulation unit defined according to claim 1, comprising at least one program instructions which, when interpreted or executed by the processing means, trigger the implementation of a regulation method, wherein said regulation method comprises the steps of a. storing at least one of i. a plurality of respectively estimated average electrical production values and ii. estimated average electrical consumption values for at least one of i. each production unit and ii. each consumption unit, respectively, for a plurality of given time periods;
b. decoding of at least one of i. the instantaneous electrical productions and ii. consumption measured by the measuring means;
c1. calculating at least one of i. the respective measured average instantaneous production and ii. consumption levels per given time period to obtain average instantaneous production and iii. average instantaneous consumption per given time period;
c2. calculating and recording the difference between average instantaneous production calculated in this way and an estimated production value for the same given time period if and only if such an estimated production value exists;
c3. calculating and recording the difference between the calculated average instantaneous consumption and the estimated consumption value for the same given time period if and only if such an estimated consumption value exists;
c4. generating and revising at least one of i. an estimated and previously-recorded production and ii. consumption value for one or more given future time periods based on a relationship having as parameters the estimated value and one or more differences respectively calculated for one or more given lapsed time periods;
d. regulating the system based on a function whose parameters comprise at least one of i. the estimated production and ii. consumption values for the given current time period.
